(19) United States
(12) Patent Application Publication
(10) Pub. No.: US 2002/0077918 A1
(43) Pub. Date: Jun. 20, 2002

(54) System & method for purchasing goods or services via the internet

(76) Inventors: Guy Lerner, Tel-Aviv (IL); Guy Israeli, Kefar Yehoshua (IL); Aviv Atlas, Haifa (IL)

Correspondence Address: Shahan Islam, Esq., Rosenman & Colin LLP, 575 Madison Avenue, New York, NY, 10022-2585, US

(21) Appl. No.: 09/736,873

(22) Filed: Dec. 14, 2000

(51) Int. Cl. G06F 17/60

(52) U.S. Cl. 705/26

(57) ABSTRACT

A method of performing sale transaction between a customer to a commercial web-site via financing system. Wherein the financing system acts not only for money transaction but as an agent of the of the customer.

The customer selects desirable product or service from any commercial web-site and records information relating the product/service sale. The information is routed to the financing organization. Upon receiving the said information the financing organization connects the respective web site and performs the sale transaction according to customer instructions. For the commercial web-site the financing organization is the “real” buyer who pays for the product/service, although said product/service are supplied to the customer address.

Finally, the financing organization debits the customer for the provided product or service, thus there is no direct financial transactions between the customer and the commercial web-site.

### BACKGROUND OF THE INVENTION

This invention relates generally to financial transactions and more particularly to transactions involving credit or debit cards.

The time has come where a significant amount of commerce will be conducted using distributed networks of computers such as the Internet. The reason this ground-swell of commerce will occur is the ability of a single merchant to economically reach a vast number of potential customers at substantially no costs.

Furthermore, the customers are able to review a great number of vendors and their products with the ease of a few key strokes and clicks of the mouse.

Although there are vast numbers of merchants already using such networks, the sales volume has been particularly low due to a variety of reasons. The main reason which has depressed commerce on the networks, is the difficulty to convince customers that payment transactions are safe.

Phone orders in response to merchant promotional materials create a variety of problems. One major problem is the requirements for phone lines and personnel to receive and process the phone orders. Another hurdle is the simple fact that most customers have a single phone line to their residence and this line is used by the computer for accessing the network; the customer has to disconnect from the network to make the phone order.

The most convenient and common payment methods usually involve the use of credit cards. Most customers are familiar with credit cards and use them on a daily basis.

Retail and service based businesses that cannot accept credit card payments are at a disadvantage against their competitors. In the United States alone, we are spending 250 billion dollars a year with credit cards. It is no wonder that businesses want to accept credit cards, even though it means paying a percentage of each credit payment.

The use of credit card through the internet is in partly equivalent to the use through telephone networks. The major difference between those networks is the security level. The Internet network is much more exposed to taping. Intercepting information transferred through the Internet is much easier than taping phone calls. As a result customers don't easily expose their credit cards number when paying through the Internet. Only few merchants on the be, such as Amazon, have succeeded in persuading the customers to give away their credit cards numbers.

People have some legitimate fears about giving their credit card number out over the Internet. The original Internet was an open network without any basic security provisions built in. Today most e-commerce web sites use a secure server such as SSL or S-HTTP for transporting data. These and other security precautions still don't eliminate customers' fears, as a result many methods are being developed to make purchasing products online more secure.

In order to overcome the security problems, there have been suggested many solutions.

The most known solutions, are First Virtual's, CyberCash's payment systems, and SET protocol which was developed by MasterCard and Visa.

Those solutions suffer from several deficiencies:

First and most important, in almost all solutions the customer is asked to reveal their credit card number and expose it to the merchant or any other involved third party through the internet communication lines.

Secondly, the payment system forces the merchant to modify his web-site payment system specially to fit the requirements of such payment system, Such modification is usually quite complicated, is not free of charge and requires time and effort. Each of the payment methods strives to be the standard one to be accepted by most merchants, but in practice there is no dominant method or system in the market.

These major problems prevent any of these paying systems to become popular and widely used by both sides of the e-commerce scene: the customers and the merchants.

It is clear from the foregoing that there is a need for an efficient methodology and system to accept payment over distributed communication networks satisfying the needs of both sides the customers and the merchants.

It is thus the prime object of the invention to provide a payment system and method enabling more safe and convenient procedure for conducting sale transactions through the web.

It is a further object of the invention to provide a methodology enabling safe payment transaction through the Internet network not disclosing the credit card number of the customer.

### SUMMARY OF THE INVENTION

A method of performing sale transaction between a customer to an a commercial web-site via financing system, said method comprising the steps of: Selecting any product or service by the customer from commercial web-site; Presenting by the merchant web-site sale details to the customer; Recording sale details; Connecting customer to financing system; identifying and authenticating customer by financing system; Transferring sale details and commercial web-site identification (web-site identification) from customer to the financing system; Checking customer credit by the financing system; Financing system connects commercial web-site according to received web-site identification; Identifying and authenticating financing system by the commercial site; Performing sale transaction between commercial web-ite and the financing system; Paying commercial web-site by the financing system according to sale details; Debiting customer account by the financing system according to sale details; and providing product or service by commercial web-site to customer.

### BRIEF DESCRIPTION OF THE DRAWINGS

These and further features and advantages of the invention will become more clearly understood in the light of the ensuing description of a few preferred embodiments thereof, given by way of example only, with reference to the accompanying drawings, wherein

FIG. 1 is a general diagrammatic representation of the environment in which the present invention is practiced;

FIG. 2 is a flowchart of complete sale procedure according to the present invention;

FIG. 3 is a flowchart of processing sale transaction through communication network according to first alternative of the present invention;

FIG. 4 is a flowchart of processing sale transaction through communication network according to second alternative of the present invention;

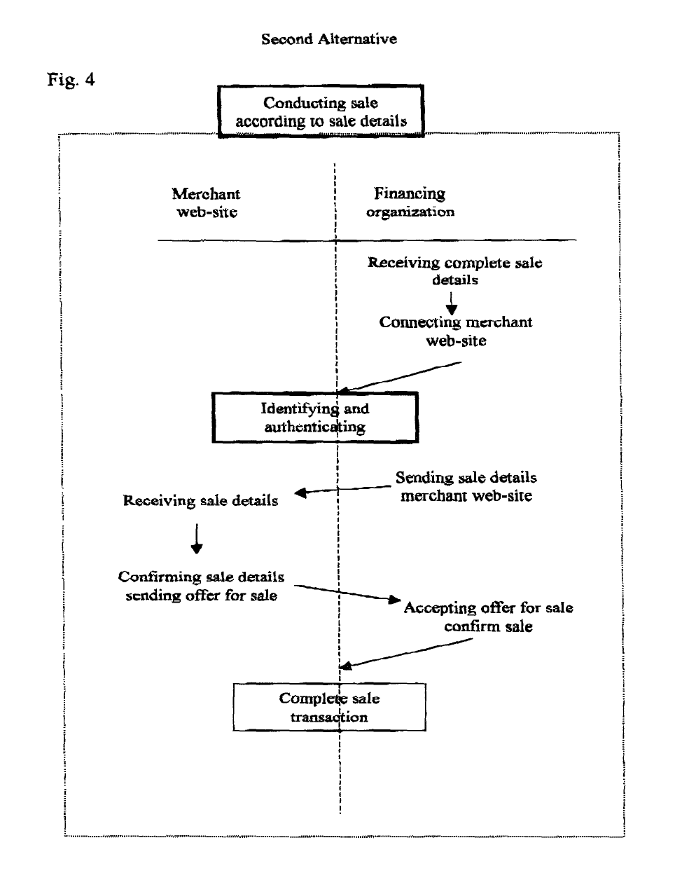

FIG. 5 is a flow-chart of processing sale transaction through communication network according to third alternative of the present invention;

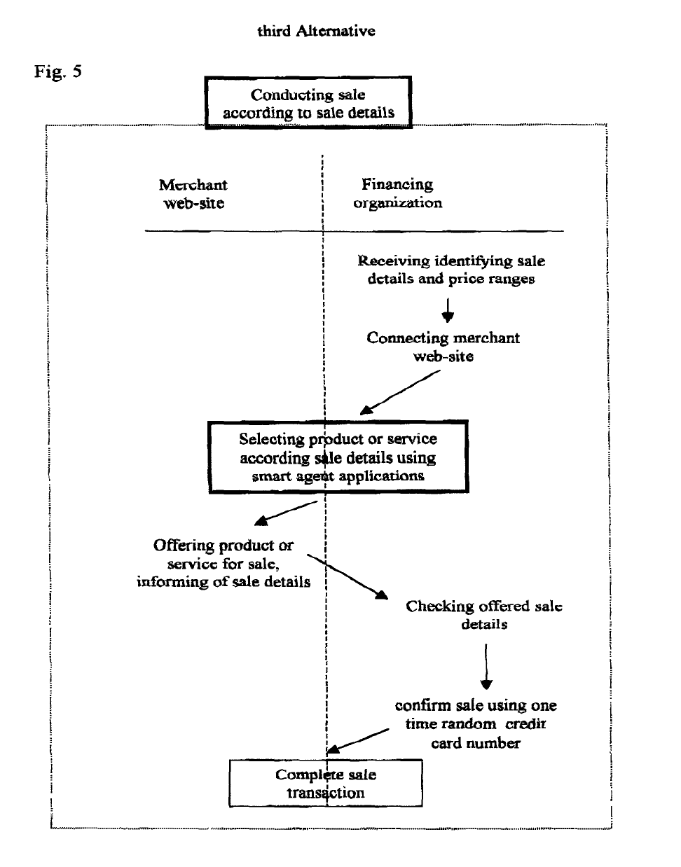

### DETAILED DESCRIPTION OF THE PREFERRED EMBODIMENTS

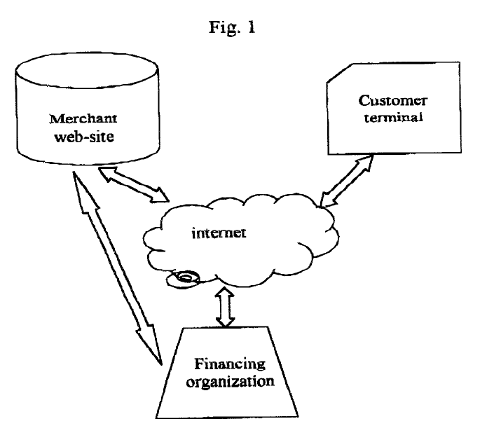

Referring to FIG. 1 of the drawings, it will be seen that a customer A is connected to the merchant web-site B on the Internet in the conventional manner. According to the present invention it is suggested to use a financing organization C such as bank or credit card issuer for intermediating between the customer and the merchant. The financing organization is involved not only in the payment transaction as known in prior art systems but take a major part in the sale procedure, acting as delegator of the customer to purchase goods or services from the merchant.

Let us assume that the customer A decides to acquire goods or services from merchant website B. According to prior art methods the user had to enter his credit card number in order to complete the sale transaction. In few web-sites the customers enters his credit card number just the first time, the credit card is stored at the web-site database, hence the next time the customer visits the same web-site, his credit number is retrieved form the database and used for new payments, eg. AMAZON web-site. Never the less, all merchant keeps databases of all customers' credit card numbers. Such databases become desirable target for hackers.

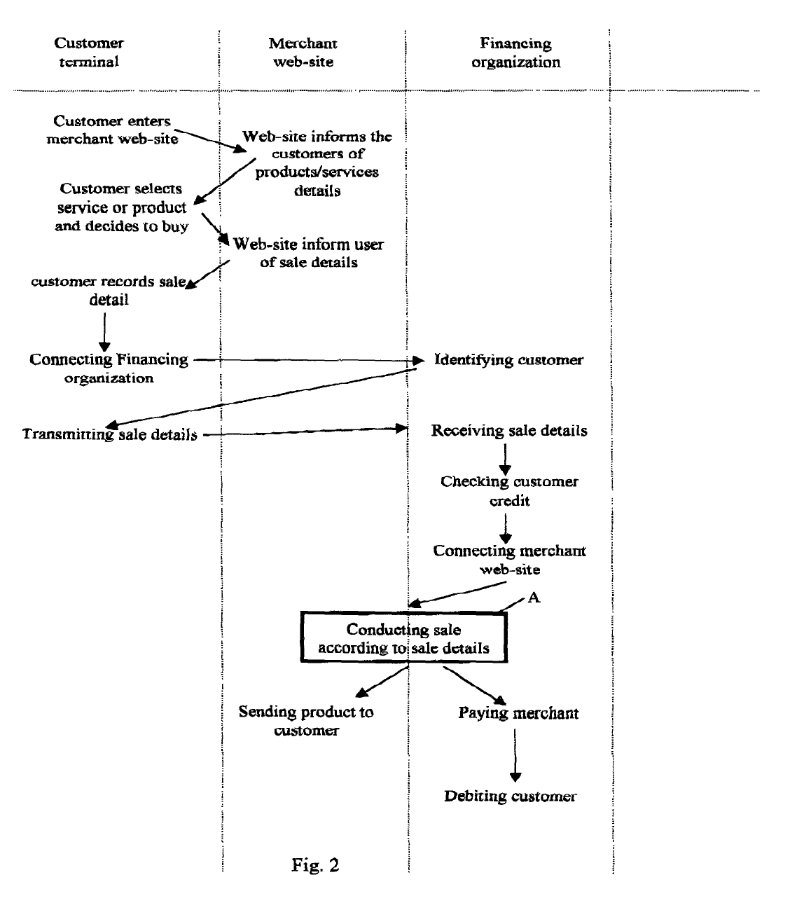

According to the method of the present invention the merchant is never provided with the credit card number of the customer and the credit card number is never sent on the Internet. The general process of performing sale is illustrated in the FIG. 2. First the customer chooses product or service from available selection on the merchant web-site, at this point the procedure can be implemented using three alternative options.

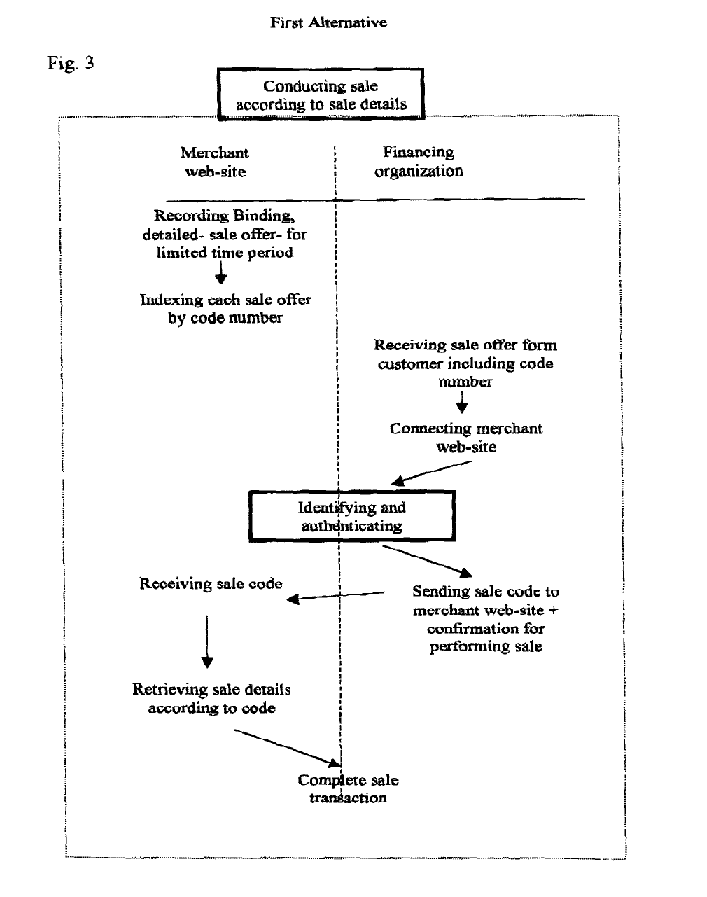

According to first embodiment of the present invention. as illustrated in FIG. 3, the customer completes the sale process till the last step before conducting the payment transaction. At this point, the customer is provided with full details of the sale. In conventional commercial web-site the customer is provided with an offer of sale (“sale offer”) presented as shopping cart which is identified by a code number.

It is suggested according to the first option that this sale offer will be recorded by both sides, customer and merchant. Optionally the merchant will hold the sale offer record just temporarily for a limited time period. At this stage the customer connects directly to the financing organization. The financing organization identifies and authenticates the customer using any possible security and identifying means including virtual coding e.g. pin codes or physical means such as smart cards readers. The process as described above can be implemented by using applet utilities as follows: after the user accepts the sale offer, he clicks on “purchasing via credit organization” hyperlink option, as a result an applet program in the merchant web-site is activated This applet program performs two activities; first, its stores the sale offer at the merchant memory, then, it activates the user browser to open new window at new network location preferably at the financing organization web-site (“financing server”) and transfers the sale offer code number and merchant identification thereof. At this point the customer identifies and transmits full sale details of the sale offer. The financing organization checks if the sale payment amount is in the limits of the customer credit. If the answer is positive the financing organization proceeds the sale transaction, according to the first option, the sale code is transferred to the merchant web-site accompanied with payment order confirming the sale performance. The merchant web-site retrieves the offer sale and completes the sale transaction accordingly. According to a second option the financing organization transmits only the sale offer code with no final confirmation. The final confirmation is transferred only after checking if sale offer details as provided by the merchant match the sale offer details of the customer.

The sale transaction is processed as any conventional payment transaction wherein the financing organization acts as a buyer. Once the payment transaction is complete, the merchant delivers the product or provides the service to the original customer and the financing organization debits the customer credit account.

FIG. 2 illustrates the embodiment of the present invention for implementing the process of conducting the sale. According to this option, after the user selected a product or service from the merchant web-site, he is provided with all details necessary for completing the sale transaction (including posting destination zone). The user records these details and transmits them with the merchant network location to the financing organization. According to this option the merchant and financial organization are connected via designated communication channel preferably the internet using designated software application, enabling to conduct the sale transaction according to the sale details received from the customer. Using such procedure the merchant is not required to record and put on hold status customers orders. The designated software application provides interactive ordering system adapted specially for the use of the financing organization The customer is provided with the same application of the first option enabling to record sale details (instead of sale offer) and merchant web-site identification such as web-site location and transfer the information to the financing organization.

The main disadvantage of the first and second options is the need to adapt and change the merchant web-site application for using the procedure of the present invention. Hence, the use of the system according to the present invention is limited only to merchants who are willing to take part and change their web-sites.

To avoid the deficiencies of the first options it is proposed according to third embodiment of present invention to provide the financing organization with designated software application enabling to simulate the purchasing procedure as if processed by a “real” customer. Such designated software usage will receive the sale detail, (not necessarily full sale details, just minimum detail for identifying product and merchant and price ranges) connect the merchant web-site and perform the whole purchasing process, including: locating and choosing product or service from available selection in the merchant site, filling Lip all order details and confirming the sale transaction. For conducting the sale transaction the financing organization must provide the merchant site with credit number, it is suggested according to the present invention that to generate random, one time use credit numbers by the financing organization and thus prevent fraud.

The process as described above can be implemented by using known smart agent technologies for searching and locating data at the remote server, for example using API (Application Program Interface) environment which is used to define software Interface to the commercial web-site products and to the entire purchase process.

Placing an order by financing organization at the commercial site and performing the sale transaction can be implemented using EDI (electronic data interchange) standards which provide tool for exchanging business document between the parties.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method of performing sale transaction between a customer to a commercial web-site via financing system, said method comprising the steps of:
(a) Selecting any product or service by the customer from commercial web-site;
(b) Presenting by the merchant web-site sale details to the customer;
(c) Recording sale details;
(a) Connecting customer to financing system;
(a) Identifying and authenticating customer by financing system;
(f) Transferring sale details and commercial web-sits identification (web-site identification) from customer to the financing system;
(g) Checking customer credit by the financing system;
(h) Financing system connects commercial web-site according to received web-site identification;
(i) Identifying and authenticating financing system by the commercial site;
(i) Performing sale transaction between commercial web-site and the financing system;
(k) Paying commercial web-site by the financing system according to sale details;
(l) Debiting customer account by the financing system; according to sale details,
(m) Providing product or service by commercial web-site to customer

2. The method of claim 1 wherein the sale details represent an offer of sale (“sale offer”) includes: sale offer code, sale amount, time and date of sale, product/service IDS etc;

3. The method of claim 2 further comprising the step of recording the first sale details by the commercial web-site;

4. The method of claim 3 wherein step (j) Comprise the following steps;
(n) Transmitting sal offer code with payment order and sale confirmation from financing system to commercial web-site;
(o) Retrieving sale details by commercial mb-site according to sale offer code;
(p) Transmitting sale conformation from commercial web-site to the financing system;
(q) Performing sale transaction between merchant and financing organization according to sale offer details wherein the financing organization acts as a buyer.

5. The method of claim 4 wherein stage (c), (d) and (n) are implemented by an applet program located at the commercial web-site server.

6. The method of claim 5 wherein the applet program performs the flowing steps:
(r) Recording sale offer;
(s) Activating new browser window at the customer terminal to connect the customer to the financing organization web site
(t) Transferring sale offer code and commercial web-site identification to financing organization web site;

7. The method of claim 1 wherein sale detail include all necessary details for performing the sale transaction;

8. The method of claim 7 wherein step (j) comprise the following steps;
(u) Transmitting sale details from financing system to commercial web-site;
(v) Checking sale details by commercial web-site;
(w) Transmitting sale confirmation including sale offer from commercial web-site to the financing system;
(x) Performing sale transaction between merchant and financing organization according to sale offer details wherein the financing organization acts as a buyer.

9. The method of claim 1 wherein step (J) comprise the following steps;
(y) Selecting products/services according to sale details and customer preferences (e.g. price ranges) in commercial web-site by the financing organization;
(z) Preparing and Transmitting sale offer including complete sale details from commercial web-site to the financing system;
(aa) Confirming complete sale details by the financing system;
(bb) Performing sale transaction between merchant and financing organization according to sale offer details wherein the financing organization acts as a buyer.

10. The method of claim 9 wherein stage Y is implemented by a smart agent applications for searching data in the commercial web-site server

11. A system of performing sale transaction between a customer to a commercial web-site via financing system, said system comprised of:
(a) Storing means for recording sale details;
(b) Communication means for connecting customer to financing system;
(c) Detecting means for identifying and authenticating customer by financing system;
(d) Communication means for transferring sale details and commercial web-site identification and/or address from customer to the financing system;
(e) Verifying means for checking customer credit by the financing system;
(f) Communication means for connecting financing system to commercial web-site according to received identification and/or address;
(g) Identifying means for detecting and authenticating financing system by the commercial site;
(h) Means for performing sale transaction between commercial web-site and the financing system;
(i) Financial means for paying commercial web-site by the financing system according to sale details and debiting customer account by the financing system according to sale details;

12. The system of claim 11 wherein the sale details represent an offer of sale (“sale offer”) include: sale offer code, sale amount, time and date of sale, product/service IDs etc;

13. The system of claim 12 further comprising storing means for recording the first sale details by the commercial web-site;

14. The system of claim 3 wherein the means for performing the sale transaction further comprise:
(j) Means for transmitting payment order and sale confirmation from financing system to commercial web-site according to sale offer code;
(k) Means for retrieving sale details by commercial web-site according to sale offer code and confirming the sale by the commercial web-site.
(l) Means for performing sale transaction between merchant and financing organization according to sale offer details wherein the financing organization acts as a buyer.

15. The system of claim 14 wherein means (d) and (f) are implemented by an applet program located at the commercial web-site server.

16. The system of claim 15 wherein the applet program is comprised of
(m) Navigating/Browsing means for directing the customer terminal to connect the financing organization web site
(n) Communication means for transferring sale offer code and commercial web-site identification to financing organization web site;

17. The system of claim 11 wherein sale detail include all necessary details for performing the sale transaction;

18. The system of claim 17 wherein the means for performing the sale transaction further comprise:
(o) Communication means for transmitting sale details from financing system to commercial web-site;
(p) Verifying means for checking sale details by commercial web-site;
(q) Communication means for transmitting sale confirmation including sale offer from commercial web-site to the financing system;
(r) Means for performing sale transaction between merchant and financing organization according to sale offer details wherein the financing organization acts as a buyer.

19. The system of claim 1 wherein the means for performing the sale transaction further comprise.
(s) Means for selecting products/services according to sale details and customer preferences (e.g. price ranges) in commercial web-site by the financing organization;
(t) Means for preparing and transmitting sale offer including complete sale details from commercial web-site to the financing system;
(u) Verifying means for confirming complete sale details by the financing system;
(v) Means for performing sale transaction between merchant and financing organization according to sale offer details wherein the financing organization acts as a buyer.

20. The system of claim 9 wherein the means for selecting products is implemented by a smart agent applications for searching data and placing a complete order in the commercial web-site server.
